(19) United States
(12) Patent Application Publication
(10) Pub. No.: US 2002/0049900 A1
(43) Pub. Date: Apr. 25, 2002

(54) Method and apparatus for cryptographic stateless protocol using asymmetric encryption

(75) Inventor: Kyle N. Patrick, Maple Ridge (CA)

Correspondence Address: Jeanine S. Ray-Yarletts, IBM Corp., Dept. T81/Bldg. 503-3, P.O.Box 12195, Research Triangle Park, NC, 27709, US

(73) Assignee: International Business Machines Corporation, Armonk,New York, 10504

(21) Appl. No.: 09/754,863

(22) Filed: Jan. 5, 2001

(30) Foreign Application Priority Data
Oct. 6, 2000 (CA) 2,322,597

(51) Int. Cl. H04L 9/00

(52) U.S. Cl. 713/151

(57) ABSTRACT

Prior methods of encryption of the token or “cookie” communicated to a client by a server use a symmetric method of encryption which does not permit the client to look at the state information. The present invention permits the client to view the state information, but not modify it, by using an asymmetric encryption method.

### TECHNICAL FIELD

The invention relates to the field of client-server communications in a computer network such as the Internet, and more particularly to methods of performing a secure stateless server protocol where the client stores the encrypted state information.

### BACKGROUND ART

Computer networks such as the Internet involve communication between a first subset of computers which are the source of information and documents, referred to herein as “servers”, and a second subset of computers which request such information and documents from servers, referred to herein as “clients”. The most ubiquitous system for exchange of information between clients and servers is the World Wide Web. The following terms are well understood in the art and have been defined in a Glossary set out in U.S. Pat. No. 5,961,601 owned by the applicant herein, which patent is incorporated herein by reference: World Wide Web; Web Browser; Universal Resource Locator (URL); Hyperlink; Hypertext Markup Language (HTML); Hypertext Transfer Protocol (HTTP). Such meanings are adopted herein unless a different meaning is specified. Clients obtain documents formatted in HTML from servers over the Internet using HTTP by linking an HTML-compatible browser to the server's URL.

HTTP is a stateless protocol in that each request sent from a client using the protocol is treated independently. The server does not keep any record of previous requests (that is, an HTTP communication does not carry with it any state information). In that case the server is referred to 25 as a “stateless” server. Such a stateless protocol has advantages in terms of server efficiency. A stateless server is faster and more scalable as it is not required to store the state information of multiple clients. In many situations, however, it is useful for the client to retain information about a session after the session is closed, and then communicating the state information to the server when the next communication between that client and that server is made. See U.S. Pat. No. 5,774,670 Montulli issued Jun. 30, 1998 to Netscape Communications Corp. and U.S. Pat. No. 5,774,670 Montulli issued Oct. 20, 1998 also to Netscape Communications Corp. which describe the communication of state information from the server to the client in a state object called a “cookie”, which is stored at the client and contains the URL to which it is to be repeated back. A client containing such state information is referred to as “stateful”.

Sometimes it may be undesirable for a client to modify the “cookie” or token which it is storing (cookies or tokens are types of information containing objects referred to herein as “state objects”). For example, where the token contains an expiry date, it is undesirable to allow the client to modify that expiry date. Consequently a method involving the encryption of the token has been developed. See U.S. Pat. No. 6,065,117 White issued May 16, 2000 to International Business Machines Corp. According to that method, a symmetric method of encryption is used. A seed value, which is some dynamic variable such as the client's network address, is used to generate a symmetric key to encrypt a token sent to the client. The encrypted token is returned to the client. The token therefore cannot be read or modified by the client. It may be important however to permit the client to read, but not modify, the token or “cookie”. There is a need therefore for a method of providing secure state information between a stateless server and a stateful client which permits the client to read but not modify the state object.

Methods of public key encryption are well known in the art. Unlike symmetric methods of encryption, where the sender and the recipient use the same code to encrypt and decrypt the message, public key encryption is asymmetric encryption. In this form of encryption, the server has a pair of keys. One key is a public key, which can be made freely available to clients. The other key carefully guarded by the server is a private key. A message encoded with the particular public key can only be decoded using the corresponding private key, and vice versa.

Disclosure of Invention

The present invention therefore provides a method of communicating state information between a server and a client having a memory, the method comprising the steps of i) providing an asymmetric encryption method having a public key provided to said client and the server and a private key provided to the server; ii) the client communicating a client request to the server to perform a server action; iii) the server responsive to receiving the client request, performing the server action and creating a state object containing post-action state information; iv) encrypting the state object using the private key; v) communicating the encrypted state object and a result of the server action to the client; and vi) storing the encrypted state object in the client memory. The method according to the invention may comprise the further step of the client decrypting the state object using the public key. According to a further aspect of the invention, the method further comprises the steps of: vii) the client communicating a subsequent client request to the server to perform a server action and the server receiving from the client the encrypted state object with the subsequent client request; and viii) the server, responsive to receiving the subsequent client request, decrypting the received encrypted state object using the public key.

According to a further aspect of the invention, the invention further comprises the step of: ix) the server, after decrypting the received encrypted state object, verifying whether the received state object has been modified. According to a further aspect of the invention, the invention further comprises the steps of: x) the server, after verifying that the received state object has not been modified, using state information contained therein to perform the requested action; xi) responsive to performing the requested action, replacing previous state information with new state information in the state object; xii) encrypting the state object with the private key; and xiii) sending the encrypted state object and a result of the server action to the client.

The present invention further provides a data processing system for communicating state information between a server and a client having a memory, the data processing system comprising: i) means for receiving a client request to perform a server action; ii) means, responsive to the client request receiving means, for performing the server action and creating a state object containing postaction state information; iii) means for encrypting the state object comprising an asymmetric encryption method having a public key provided to the client and the server and a private key provided to the server; and iv) means for communicating the encrypted state object and a result of the server action to the client.

According to a further aspect ofthe invention, the invention further comprises: v) means for receiving from the client the encrypted state object with a subsequent client request to perform a server action; vi) means, responsive to the means for receiving the subsequent client request, for decrypting the received encrypted state object using the public key; and vii) means for verifying whether the received state object has been modified. According to a further aspect of the invention, the invention further comprises viii) means, responsive to the verifying means, for using state information contained in the state object to perform the requested server action; ix) means for replacing previous state information with new state information in the state object; x) means for encrypting the state object using the private key; and xi) means for sending said encrypted state object and a result of the server action to the client. According to a further aspect of the invention, the invention further comprises means for receiving said encrypted state object; means for decrypting said state object using said public key; and means for storing said encrypted state object.

The invention further comprises a computer program product for communicating state information between a server and a client having a memory and provided with a public key of an asymmetric encryption method, the computer program product comprising: a computer usable medium having computer readable program code means embodied in the medium for receiving a client request to perform a server action; the computer usable medium having computer readable program code means embodied in the medium, responsive to the client request receiving means, for performing the server action and creating a state object containing post-action state information; the computer usable medium having computer readable program code means embodied in the medium for encrypting the created state object with the private key of the asymmetric encryption method; and the computer usable medium having computer readable program code means embodied in the medium, responsive to the encrypting means, for sending the encrypted state object and a result of the server action to the client.

According to a further aspect of the invention, the invention further comprises: computer readable program code means embodied in the medium for receiving from the client the encrypted state object with a subsequent client request to perform a server action; computer readable program code means embodied in the medium, responsive to the means for receiving the subsequent client request, for decrypting the received encrypted state object using the public key; and computer readable program code means embodied in the medium, responsive to the decrypting means, for verifying that the received state object whether the received state object has been modified.

The invention further comprises a computer program product for communicating state information between a server and a client having a memory, the server provided with a public key and a private key of an asymmetric encryption method and the client provided with a public key of an asymmetric encryption method, the computer program product comprising: a computer usable medium having computer readable program code means embodied in the medium for sending a client request to perform a server action; the computer usable medium having computer readable program code means embodied in the medium for receiving the results of the server action and a state object containing post-action state information wherein the state object is encrypted with the private key of the asymmetric encryption method, and means for storing the state object; and the computer usable medium having computer readable program code means embodied in the medium for decrypting the state object with the public key ofthe asymmetric encryption method. According to a further aspect of the invention the computer program product further comprises computer readable program code means embodied in the medium for replacing previous state information with new state information in the state object; computer readable program code means embodied in the medium for encrypting the state object using the private key; and computer readable program code means embodied in the medium for sending the encrypted state object with new state information and a result of the server action resulting from the subsequent client request to the client.

### BRIEF DESCRIPTION OF DRAWINGS

In drawings which disclose a preferred embodiment of the invention:

FIG. 1 is a schematic illustration of a computer network according to the present invention;

FIG. 2 is a block diagram illustrating a data processing system for implementing the invention; and

FIG. 3 is a flow chart illustrating the method of the invention.

BEST MODE(S) FOR CARRYING OUT THE INVENTION

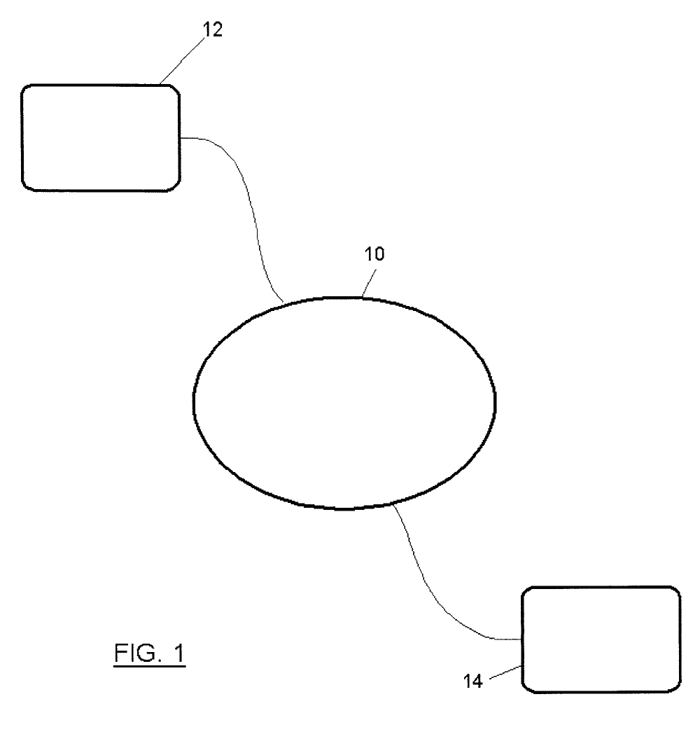

With reference to FIG. 1, a computer network is designated generally as 10. Network 10 includes a client 12 and a server 14. While in the preferred embodiment such network is the Internet, it will be apparent to those skilled in the art that the present invention also has application in any local or wide area network or “intranet” incorporating one or more clients and one or more servers.

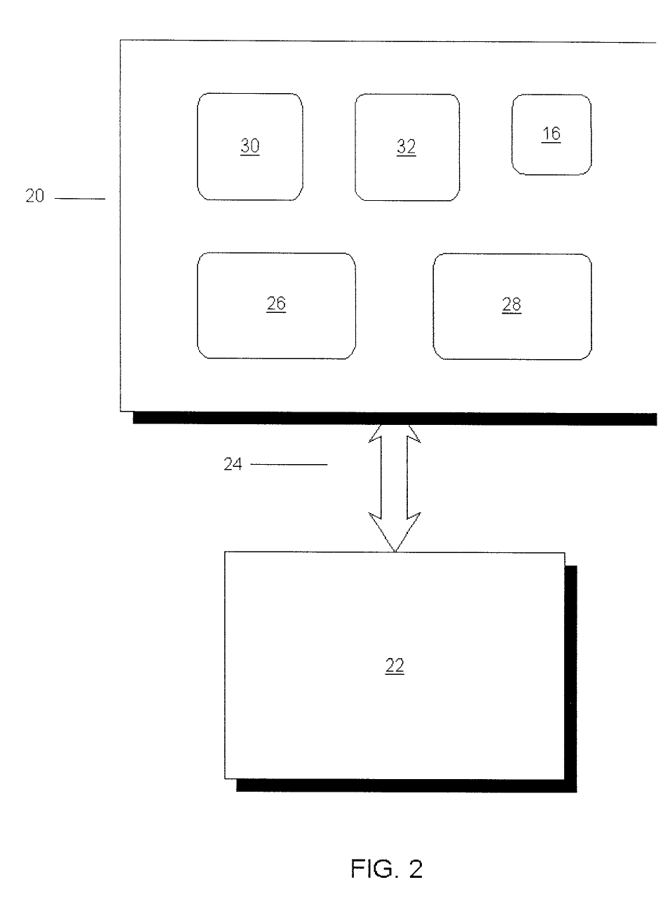

FIG. 2 illustrates a data processing system applicable to either the client 12 or server 14. It comprises a memory 20 which communicates with a central processing unit 22 by means of bus 24. Memory 20 stores an operating system 26 and applications programs which include an asymmetric encryption program 28. Memory 20 also stores, in the case of the client, the public key 30 for the encryption program, and in the case of the server 14 both the public key 30 and private key 32, and stores the state object 16.

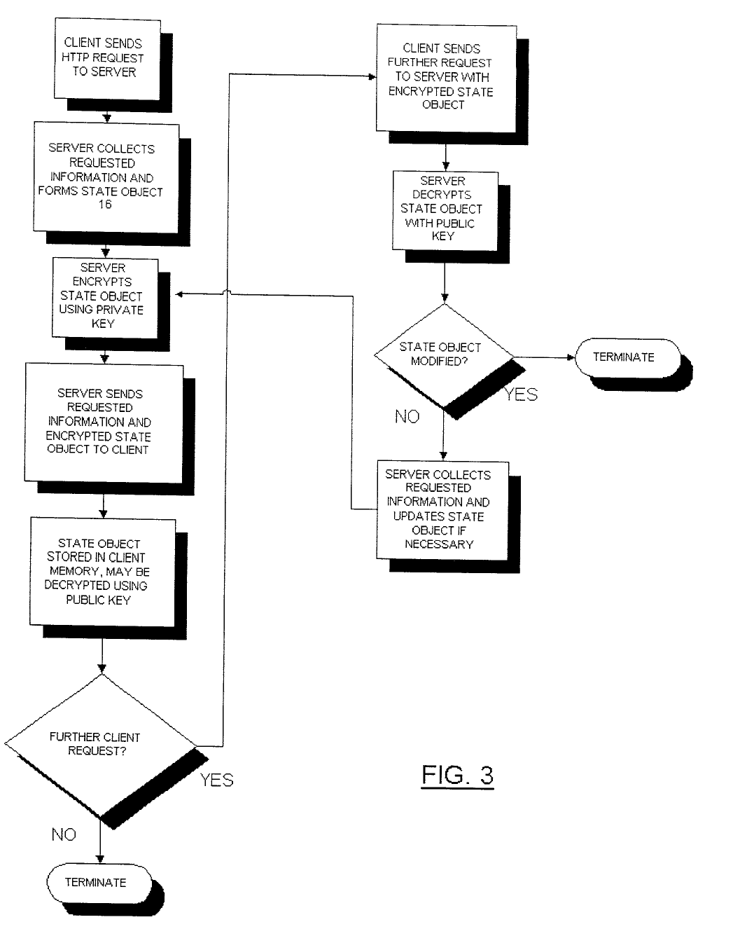

With reference to FIG. 3, the client 12 sends a stateless protocol request, such as an HTTP protocol request, to server 14. Server 14 collects the requested information, and forms a state object 16 with the desired state information, which may include the server's URL for returning the state object. Server 14 encrypts the state object using its private key. Server 14 sends the encrypted state object to client 12 along with the requested information. The state object is stored in the client's memory. The client can then use the server's public key to look at the state object, but cannot modify the state object without corrupting it. When the client 12 makes another request to server 14 the encrypted state object is returned with the request and the server uses its public key to verify that the state object has not been tampered with. It then obtains the requested information. If a new or updated state object is desired, it prepares and encrypts the new state object with its private key. The requested information and encrypted state object is then returned to the client 12 and the encrypted state object 16 is again saved in the memory of client 12.

The present invention is described above as a computer-implemented method and data processing system. It may also be embodied as a computer hardware apparatus, computer software code or a combination of same. The invention may also be embodied as a computer-readable storage medium embodying code for implementing the invention. Such storage medium may be magnetic or optical, hard or floppy disk, CD-ROM, firmware or other storage media.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

The embodiments of the invention in which an exclusive property or privilege is claimed are defined as follows:

1. A method of communicating state information between a server and a client having a memory, the method comprising the steps of:
i) providing an asymmetric encryption method having a public key provided to said client and said server and a private key provided to said server;
ii) said client communicating a client request to said server to perform a server action;
iii) said server responsive to receiving said client request, performing said server action and creating a state object containing post-action state information;
iv) encrypting said state object using said private key;
v) communicating said encrypted state object and a result of said server action to said client; and
vi) storing said encrypted state object in said client memory.

2. A method according to claim 1, further comprising the steps of:
vii) said client communicating a subsequent client request to said server to perform a server action and said server receiving from said client said encrypted state object with said subsequent client request; and
viii) said server, responsive to receiving the subsequent client request, decrypting said received encrypted state object using said public key.

3. The method according to claim 2, further comprising the step of:
ix) said server, after decrypting said received encrypted state object, verifying whether said received state object has been modified.

4. The method according to claim 1 wherein said server is stateless and said client is stateful.

5. The method according to claim 1 comprising the further step of said client decrypting said state object using said public key.

6. The method according to claim 3, said method comprising the further steps of:
x) said server, after verifying that said received state object has not been modified, using state information contained therein to perform the requested action;
xi) responsive to performing the requested action, replacing previous state information with new state information in said state object;
xii) encrypting said state object with said private key; and
xiii) sending said encrypted state object and a result of said server action to the client.

7. A data processing system for communicating state information between a server and a client having a memory, said data processing system comprising:
i) means for receiving a client request to perform a server action;
ii) means, responsive to said client request receiving means, for performing said server action and creating a state object containing post-action state information;
iii) means for encrypting said state object comprising an asymmetric encryption method having a public key provided to said client and said server and a private key provided to said server; and
iv) means for communicating said encrypted state object and a result of said server action to said client.

8. A data processing system according to claim 7, further comprising:
v) means for receiving from said client said encrypted state object with a subsequent client request to perform a server action;
vi) means, responsive to said means for receiving said subsequent client request, for decrypting said received encrypted state object using said public key; and
vii) means for verifying whether said received state object has been modified.

9. A data processing system according to claim 8, further comprising:
viii) means, responsive to said verifying means, for using state information contained in said state object to perform said requested server action;
vi) means for replacing previous state information with new state information in said state object;
vii) means for encrypting said state object using said private key; and
viii) means for sending said encrypted state object and a result of said server action to said client.

10. The data processing system according to claim 9 further comprising means for receiving said encrypted state object; means for decrypting said state object using said public key; and means for storing said encrypted state object.

11. A computer program product for communicating state information between a server and a client having a memory, said server provided with a public key and a private key of an asymmetric encryption method and said client provided with a public key of an asymmetric encryption method, said computer program product comprising:
a computer usable medium having computer readable program code means embodied in said medium for receiving a client request to perform a server action;
said computer usable medium having computer readable program code means embodied in said medium, responsive to said client request receiving means, for performing said server action and creating a state object containing post-action state information;
said computer usable medium having computer readable program code means embodied in said medium for encrypting the created state object with the private key of said asymmetric encryption method; and
said computer usable medium having computer readable program code
means embodied in said medium, responsive to said encrypting means, for sending said encrypted state object and a result of said server action to said client.

12. A computer program product according to claim 11, further comprising:
computer readable program code means embodied in said medium for receiving from said client said encrypted state object with a subsequent client request to perform a server action;
computer readable program code means embodied in said medium, responsive to said means for receiving the subsequent client request, for decrypting said received encrypted state object using said public key; and
computer readable program code means embodied in said medium, responsive to said decrypting means, for verifying that the received state object whether said received state object has been modified.

13. A computer program product according to claim 12, further comprising:
computer readable program code means embodied in said medium for replacing previous state information with new state information in said state object;
computer readable program code means embodied in said medium for encrypting said state object using said private key; and
computer readable program code means embodied in said medium for sending said encrypted state object with said new state information and a result of said server action resulting from said subsequent client request to said client.

14. A computer program product for communicating state information between a server and a client having a memory, said server provided with a public key and a private key of an asymmetric encryption method and said client provided with a public key of an asymmetric encryption method, said computer program product comprising:
a computer usable medium having computer readable program code means embodied in said medium for sending a client request to perform a server action;
said computer usable medium having computer readable program code means embodied in said medium for receiving the results of said server action and a state object containing post-action state information wherein said state object is encrypted with said private key of said asymmetric encryption method, and means for storing said state object; and
said computer usable medium having computer readable program code means embodied in said medium for decrypting said state object with the public key of said asymmetric encryption method.
